(19) United States
(12) Patent Application Publication
(10) Pub. No.: US 2002/0080808 A1
(43) Pub. Date: Jun. 27, 2002

(54) Dynamically modifying network resources for transferring packets in a vlan environment

(76) Inventor: Mun Keung Leung, Redwood City, CA (US)

Correspondence Address: Arthur I. Navarro, Navarro IP Law Group, Suite 655, 801 E. Campbell Rd., Richardson, TX, 75081, US

(21) Appl. No.: 09/745,536

(22) Filed: Dec. 22, 2000

(51) Int. Cl. H04L 12/56

(52) U.S. Cl. 370/412

(57) ABSTRACT

Disclosed is a method (100) for any Virtual Local Area Network (VLAN) environment, for handling of packet data within the VLAN environment. The method (100) comprises receiving a data packet (61) in a VLAN-aware device. Next, examining a plurality of attributes of the data packet (61). Finally, modifying the priority queue of the data packet (61) in relationship to the nature of the attributes.

### TECHNICAL FIELD

This invention relates in general to communication networks and applications and, in particular, to a method and system of dynamically modifying resources for transferring data packets in a VLAN environment. More particularly, the invention relates to methods for modifying the priority queue of a data packet in a VLAN aware communications network.

### BACKGROUND OF THE INVENTION

Without limiting the scope of the invention, its background is described in connection with modifying network resources for transferring data packets within a VLAN environment, as an example. Present day communication networking has changed rapidly with advances in both computer and telecommunications networks. The computer industry, in particular, is a rapidly growing and changing industry with advances, improvements, and technological breakthroughs occurring on an almost daily basis. The networking of computers has added a great deal of functionality to the standard desktop computer. Resources may be shared and computers joined to create networks, allowing people to work together more conveniently. In order to allow computers to work together, the Institute of Electrical and Electronics Engineers, Inc. (IEEE) has created standards to promote commonality and interchangeability throughout various disciplines of the electronic arts. For example, IEEE Standard 802 defines an Ethernet network. By promoting standards, IEEE has allowed different types of devices manufactured by different companies to successfully communicate with each other.

In a traditional network, groups of computers and other devices such as printers were located on a Local Area Network (LAN). Each of these devices is generally referred to as an end node device. A LAN is the subsection of the network also known to those skilled in the art as a broadcast domain. Hubs, bridges or switches are used in the same physical segment or segments connecting all end node devices. End node devices can communicate with other end node devices on the same LAN without the need for a router.

Communications with end node devices on other LAN segments requires the use of an interface, such as a gateway device or router. Specifically, each LAN is separated from another LAN by such a device. As networks expand, more such devices are needed to separate users into LANs and provide connectivity.

One drawback to this design is increased latency, which essentially delays the transmission of data. This is caused by the process involved in routing data from one LAN to another. A router must use more of the information in a data packet to determine destinations and route the data to the appropriate end node. One disadvantage to a LAN is that network traffic between two end nodes may be excessive. LANs are often set up based on location and geographic constraints. For example, in an office building, all the computers and printers on one floor may be members of one LAN while the computers and printers on a second floor members of another LAN. However, in actual use, some of the computers of the first floor may talk to some of the computers of the second floor. At the same time, some computers on a floor may never interact with other computers on the same floor. Thus, it would be more convenient to be able to put all of the end node computers that need to talk to each other on the same LAN.

In an attempt to overcome the physical limitations of LANs, Virtual LANs (VLAN) were developed. A VLAN can be viewed as a group of devices on different physical LAN segments which can communicate with each other as if they were all on the same physical LAN segment. VLANs provide a number of benefits over a LAN. Using VLANs, it is possible to group computing devices logically into a single broadcast domain. This allows us to define broadcast traffic for this VLAN to just those devices that need to see it, thus reducing traffic to the rest of the network. There is an increased connection speed due to the elimination of latency from router connections. An additional benefit of increased security is realized if access from foreign networks is not allowed, i.e., those that originate from another subnet beyond the router.

In order to implement VLANs, IEEE has propagated Standard 802.1Q., which defines the requirements for a VLAN network. Additionally, in order to add a priority to data packets flowing through the network, IEEE has propagated Standard 802.1D to specify a 3-bit priority code, which can be encoded into the Ethernet header of the data packet. The three-bit priority code represent numbers 0 through 7, thus creating 8 choices or 8 different priorities. In a VLAN network implementing IEEE Standards 802.1Q/D, a VLAN having packets of different priorities is enabled. A disadvantage of the present priority schemes is that once a data packet has been assigned a priority, that priority cannot be changed as the data packet transition through the network. This can be problematic, especially for packets that contain critical content such as a voice packet corresponding to an emergency call. Thus, depending on the type of packet and network traffic, it is often desirable to modify the priority assignment of a data packet in order to better utilize network resources.

In summary, the prior art methods of assigning priority to data packets in a network do not provide flexibility and efficient use of network resources in relation to the packet type. A means of modifying priorities in a VLAN environment would have numerous advantages.

### SUMMARY OF THE INVENTION

The present invention provides a method and system for dynamically modifying the priority and handling of data packets in a VLAN environment. With the present invention, data packets are moved to different priority queues based on a number of attributes of the data packet.

Disclosed in one embodiment is a method of modifying the handling of data packets in a VLAN environment. The method comprises the step of receiving a data packet in a VLAN aware device. Next, a plurality of attributes associated with the data packet are examined. And, the priority queue for the data packet is modified in relation to the nature of the attributes. The attributes examined can include the port number, service used, network layer and priority tag, among others.

Further disclosed is a VLAN-aware device having a module for modifying the routing of data packets according to the attributes of the data packet and current conditions in the network. The module has means for receiving a data packet and for examining a plurality of attributes associated with the data packet. The VLAN-aware device includes a means for modifying a priority queue of the data packet in relationship to said attributes.

Also disclosed is a program product that operates in a VLAN environment and can modify the handling of a data packet within the VLAN environment. The program product comprises logic means for receiving a data packet. After receiving the data packet, the program product examines a plurality of attributes associated with the data packet. Thus, the program product receives and examines the data packet and, if appropriate, modifies the priority queue of the data packet in relationship to the nature of the attributes. The program product is capable of changing the priority queue of a data packet based on value of attributes associated with the data packet.

A technical advantage of the present invention is that it does not require changing IEEE Standard 802.1Q/D compliant data packets within the network. The data packets remain unchanged and fully compliant with the appropriate standards at all times. However, the data packets are processed with higher, lower or the same priority in VLAN-aware devices incorporating the functionality of the present invention. Since the actual data packet is not changed, it remains compliant and will successfully navigate through other portions of the network.

Yet another technical advantage of the disclosed invention is the ability to dynamically change the priority of data packets flowing through a VLAN aware device to maximize the efficient use of network resources and to accommodate different data types.

### BRIEF DESCRIPTION OF THE DRAWINGS

For a more complete understanding of the present invention including its features and advantages, reference is made to the following detailed description of the invention, taken in conjunction with accompanying drawings of which:

FIG. 1 depicts a network in which the LAN architecture of the prior art is shown;

FIG. 2 depicts a network using a VLAN architecture in which a preferred embodiment of the present invention may be implemented;

FIG. 3 shows an Ethernet header, as described in the prior art;

FIG. 4 shows an Ethernet frame and a priority tagged Ethernet frame, as is described in the prior art;

FIG. 5 depicts a VLAN-tagged packet with a priority code being used to decide what priority queue data packets should go into;

FIG. 6 depicts a data packet moving through a device using a VLAN;

FIG. 7 illustrates data packets flowing through priority queues, according to the preferred embodiment of the present invention;

FIG. 8 depicts a preferred embodiment of the present invention for modifying priority handling of data packets;

FIG. 9 represents a flow diagram for a module, according to a preferred embodiment of the present invention;

FIG. 10 is a flow chart depicting a method, according to an embodiment of the present invention; and

FIG. 11 shows the basic building blocks of a program product incorporating the functionality of the present invention.

Corresponding numerals and symbols in the figures refer to corresponding parts in the detailed description, unless otherwise indicated.

### DETAILED DESCRIPTION OF PREFERRED EMBODIMENTS

While the making and using of various embodiments of the present invention are discussed in detail below, it should be appreciated that the present invention provides many applicable inventive concepts which can be embodied in a wide variety of specific contexts. The specific embodiments discussed herein are merely illustrative of the specific ways to make and use the invention, and do not delimit the scope of the invention.

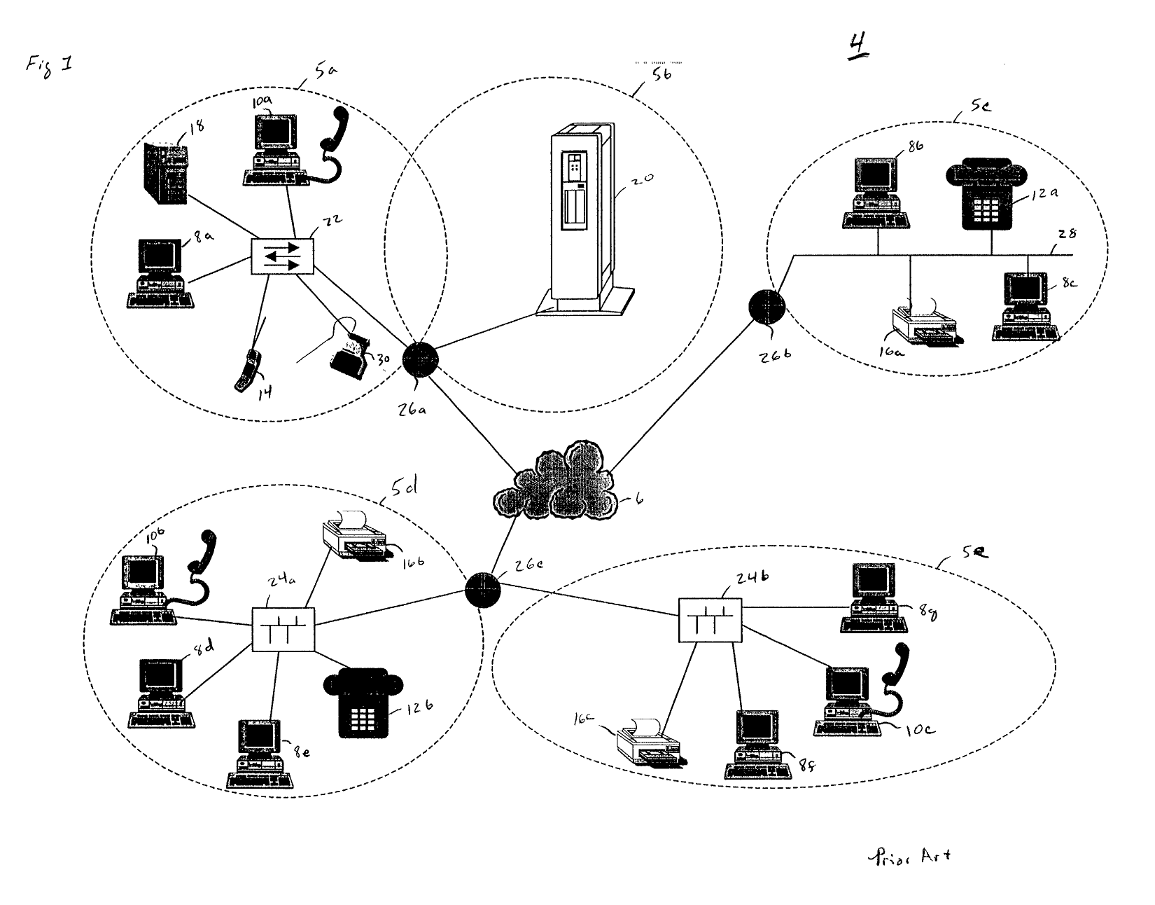

To better understand the invention, reference is made to FIG. 1, wherein a diagram of a communications network 4 in which a traditional LAN implemented is shown. A LAN is generally defined as a broadcast domain. Hubs, bridges or switches in the same physical segment or LAN connect all end node devices in the LAN. End nodes in a LAN can communicate with each other without the need for a router. Typically, end node devices are personal computers, server computers, main frame computers, printers and other devices which may be connected to the network.

Communications with devices on other LAN segments requires the use of a bridge, gateway or router, For simplicity, such devices will be referred throughout as a “router.” As can be seen in FIG. 1, several LANs 5A-5E are connected to Wide Area Network (WAN) 6. Each LAN 5A-5E is connected to a router 26A-26C to join WAN 6. LAN 5A comprises several end nodes: a personal computer 8A, a server computer 18, a wireless voice over internet protocol (VoIP) phone 14, a personal digital assistant 30, and a personal computer with VoIP access 10A. Each of these end nodes are connected through switch 22 to router 26A which permits access to other computers across WAN 6. LAN 5B comprises main frame computer 20, which is connected to WAN 6 through router 26A. Another LAN 5C is a thin Ethernet wire 28 connecting personal computer 8B, VoIP phone 12A, personal computer 8C and printer 16A to router 26B to access WAN 6.

Another LAN is shown as 5D. LAN 5D comprises a printer 16B, a personal computer with VoIP access 10B, personal computers 8D and 8E, and VoIP phone 12B. These end nodes are connected through hub 24A to router 26C to access other LANs across WAN 6. Finally, LAN 5E comprises printer 16C, personal computers 8F and 8G, and personal computer with VoIP access 10C connected through hub 24B to router 26C to access computers across WAN 6.

A disadvantage of network 4 is that each of the separate LANs 5A-5E must connect through a router 26A-26C for computers within one LAN section to talk with computers in another LAN section. Routers add latency, which essentially delays the transmission of data. This is caused by the process involved in routing data from one LAN to another LAN. The router must use more of the information in a data packet to determine destinations and route the data to the appropriate end node.

Another disadvantage is that LAN segments are typically divided by physical location. This means that computers that are near each other in a building will be connected on the same LAN segment; however, these computers may not need to communicate with each other at all. The majority of their communication may be with computers in other LAN segments. If inter-LAN communication is excessive, it can slow down the entire network since packets must travel through routers for each communication to be made.

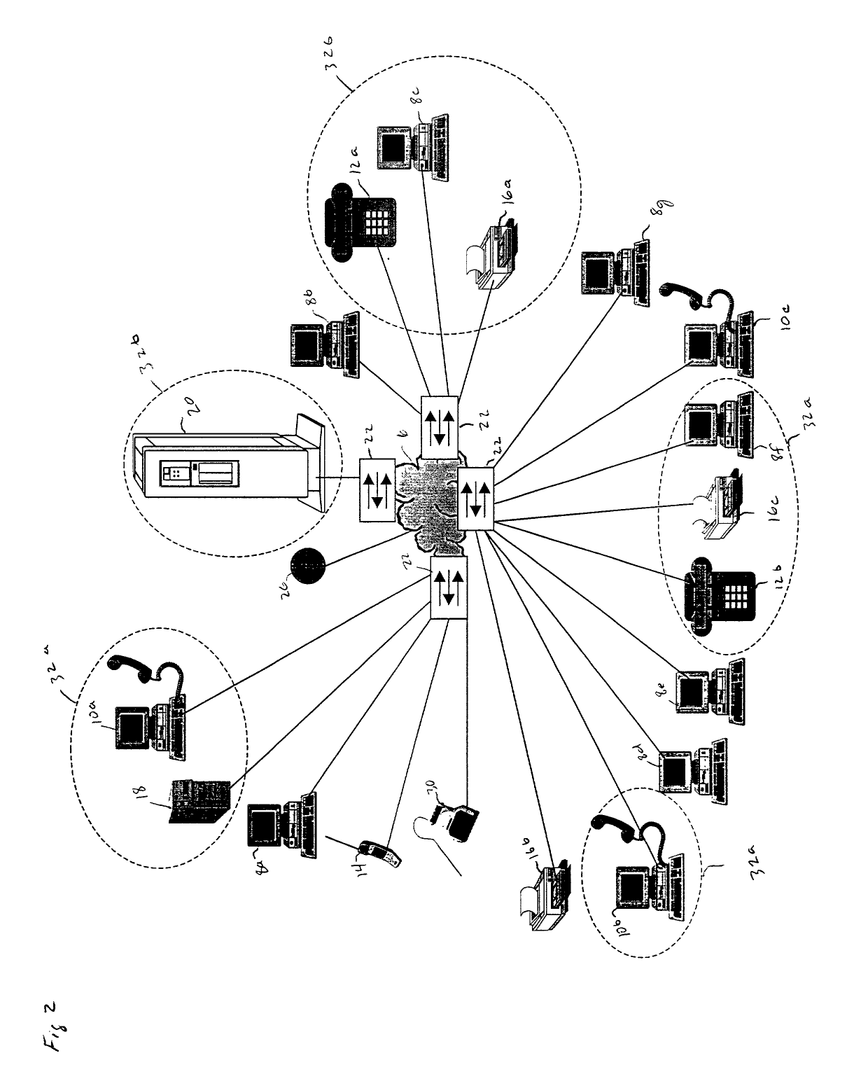

With reference to FIG. 2, therein is shown a VLAN network 4. Each end node is now connected to a switch 22 to connect to WAN 6. For access outside of WAN 6, router 26 will be utilized. However, for communications that stay within the local WAN 6, only the switches 22 will be used. Virtual LANs can be viewed as a group of devices on different physical LAN segments which communicate with each other as if they were all in the same physical LAN segment. Thus, VLAN 32A comprises server computer 18, personal computer with VoIP access 10A, VoIP telephone 12B, printer 16C, personal computer 8F, and personal computer with VoIP access 10B. Connecting these end node devices through VLAN 32A, the end node devices act as if they are on a single LAN segment. VLAN 32B is also depicted. VLAN 32B consists of main frame computer 20, personal computer 8C, printer 16A and VoIP telephone 12A.

In FIG. 1, LANs 5A-5E were grouped with physical location being the primary concern. In FIG. 2, VLANs 32A and 32B have been built with traffic patterns in mind. All of the end node devices in VLANs 32A, 32B have been grouped primarily on traffic patterns. End node devices in VLAN 32A are grouped together to confine broadcast traffic to just those end node devices that need to see it, and to reduce traffic to the rest of the network 4. Connection speeds increase due to the elimination of latency from router connections. Those skilled in the art will recognize that any combination of end nodes and switches could be utilized for network 4. The specific example in FIG. 2 is for illustrative purposes.

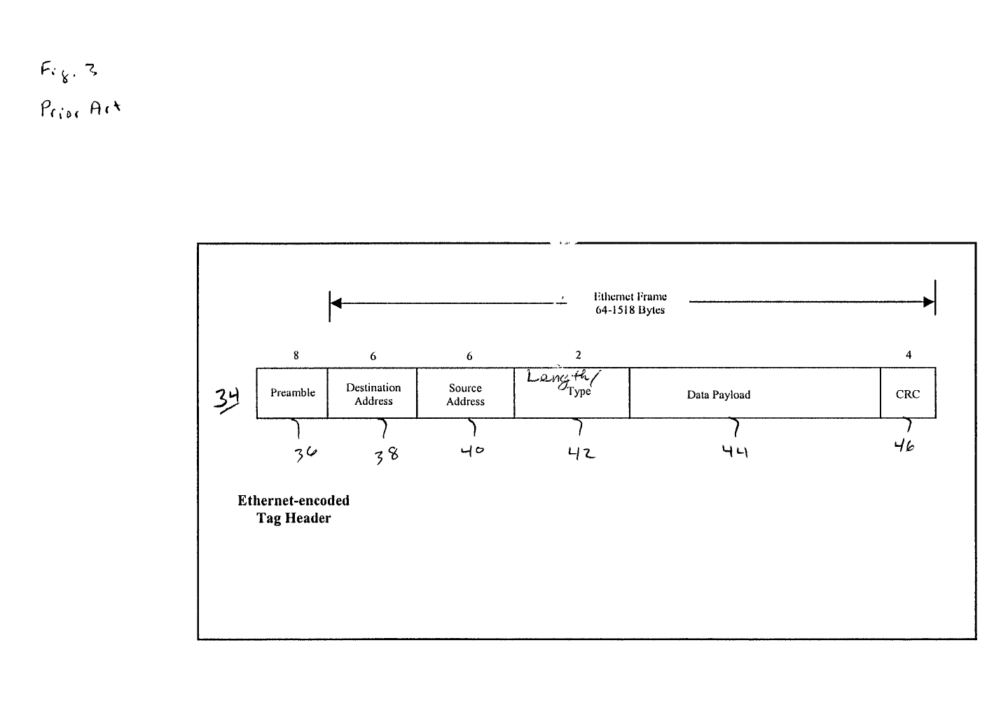

In FIG. 3, a typical Ethernet header 34 is shown. Ethernet header 34 conforms to IEEE Standard 802. Ethernet header 34 describes how information is packed into a data packet so that the information may be successfully deciphered. The first portion is called the preamble 36. Preamble 36 consists of 7 bytes of a synchronization pattern consisting of alternating 1s and 0s, which is used to ensure receiver synchronization. It also consists of one byte designated as the start frame delimiter. The start frame delimiter is similar to the other section of the preamble except that it ends with two consecutive bits set to one.

Next is the designation address 38. This is a 48-bit field which specifies to which station the packet is addressed. The first bit indicates the type of address: if it is a zero, the field gives the address of a unique station; if it is a one, the field specifies a larger group of recipients.

The next portion of the Ethernet header 34 is source address 40. Source address 40 is a unique address of the originating station as specified in this 48-bit field. Next comes the length/type 42 field which indicates the number of information bytes being supplied by the data field or the protocol type. Next is the data payload 44 field. IEEE Standard 802 recommends that data payload 44 have a length between 46 and 1500 bytes. The 46-byte minimum ensures that valid packets will be distinguishable from collision fragments. If the data supplied is less than the 46-byte minimum required for proper information of the Ethernet protocol, then an integer number of padding bytes are added to the end of the data field to bring the length to 46 bytes.

The last field is the Cyclic Redundancy Check (CRC) 46 field. This field is also referred to as the frame check sequence. CRC 46 contains a 32-bit cyclic redundancy check code for error detection, as defined by the generating polynomial G(x). CRC 46 covers the destination address, source address, and data fields and uses a linear feedback register which is initially preset to all ones. After the last bit is transmitted, the contents of this register are inverted and sent as the CRC 46 field.

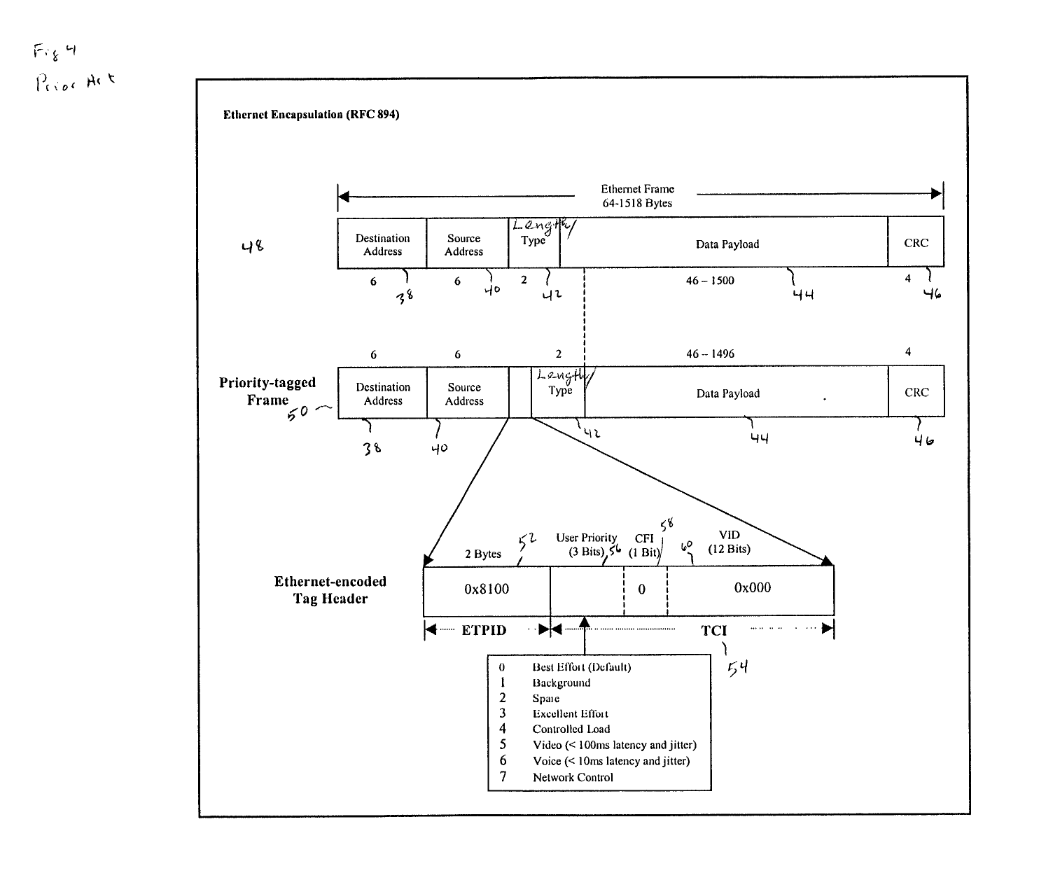

An Ethernet frame is defined as all the sections of an Ethernet header 34, except for the preamble 36. In FIG. 4, Ethernet frame 48 is depicted. Ethernet frame 48 includes destination address 38, source address 40, lenght/type 42, data payload 44 and CRC 46. In priority tagged frame 50, priority and VLAN identifier data are added. Priority tagged frame 50 comprises destination address 38, source address 40, Ethernet Tag Protocol Identifier (ETPID) 52, Tag Control Information (TCI) 54, length/type 42, data payload 44, and CRC 46. ETPID 52 is used to identify the proper protocol and implement it. In this example, it is a value of 0×8100.

The Tag Control Information 54 is comprised of three separate pieces of information. First is the priority field 56. Priority field 56 is made up of a three-bit designation which allows eight different values so that eight different priorities are available. These are represented by priority values 0 through 7. The eight different priority fields 56 are as follows: 0, best effort; 1, background; 2, spare; 3, excellent effort; 4, controlled load; 5, video; 6, voice; and 7, network control. The standard priority indicators of the priority field 56 are used to dictate the priority handling assigned to the data packet.

Next, if Canonical Format Indicator (CFI) 58 is set, the E-RIF field is present and the bit determines whether mac address information carried by the frame is in canonical or non-canonical format. If CFI 58 is not set, it indicates that the E-RIF field is not present and that all mac information carried by the frame is in canonical format. Finally, the VLAN Identifier (VID) 60 is used to uniquely identify the VLAN to which the frame belongs. A null value indicates that the tag header contains only user priority information and no VLAN ID.

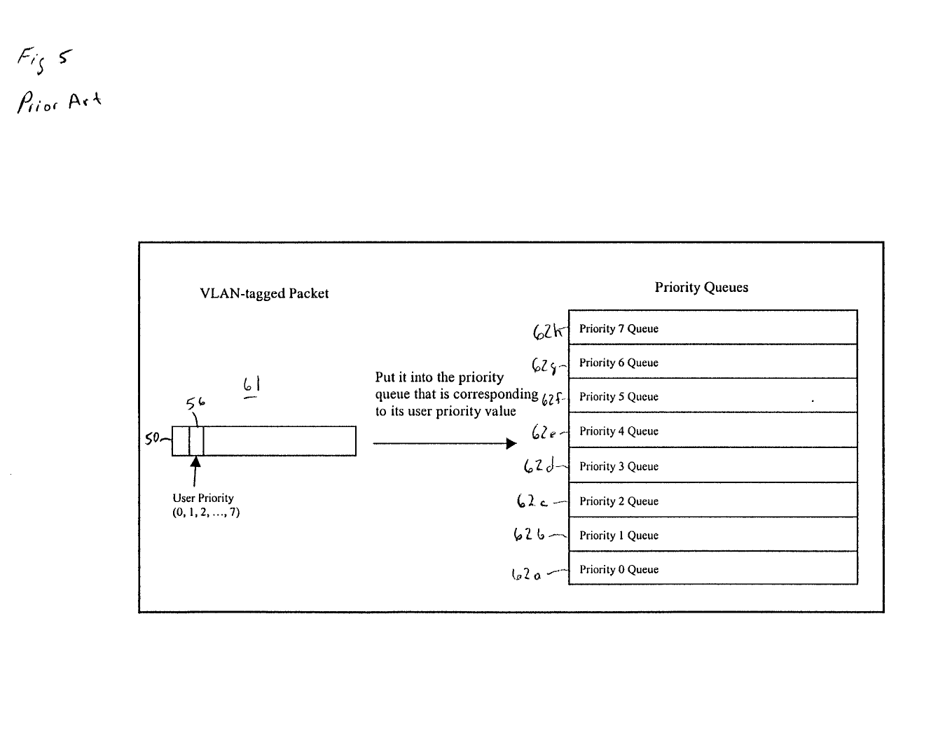

Referring to FIG. 5, data packet 61 is shown with a VLAN tag frame 50. Data packet 61 has a priority field 56 which determines which of the 8 priority queues 62A-62H data packet 61 will be put into as it traverses network 4. According to IEEE Standard 802.1Q/D, the priority value is set in the packet and may not be changed; thus, whatever priority value the packet has when it begins its journey, it will be placed in that priority queue in all VLAN-compatible queues along the route.

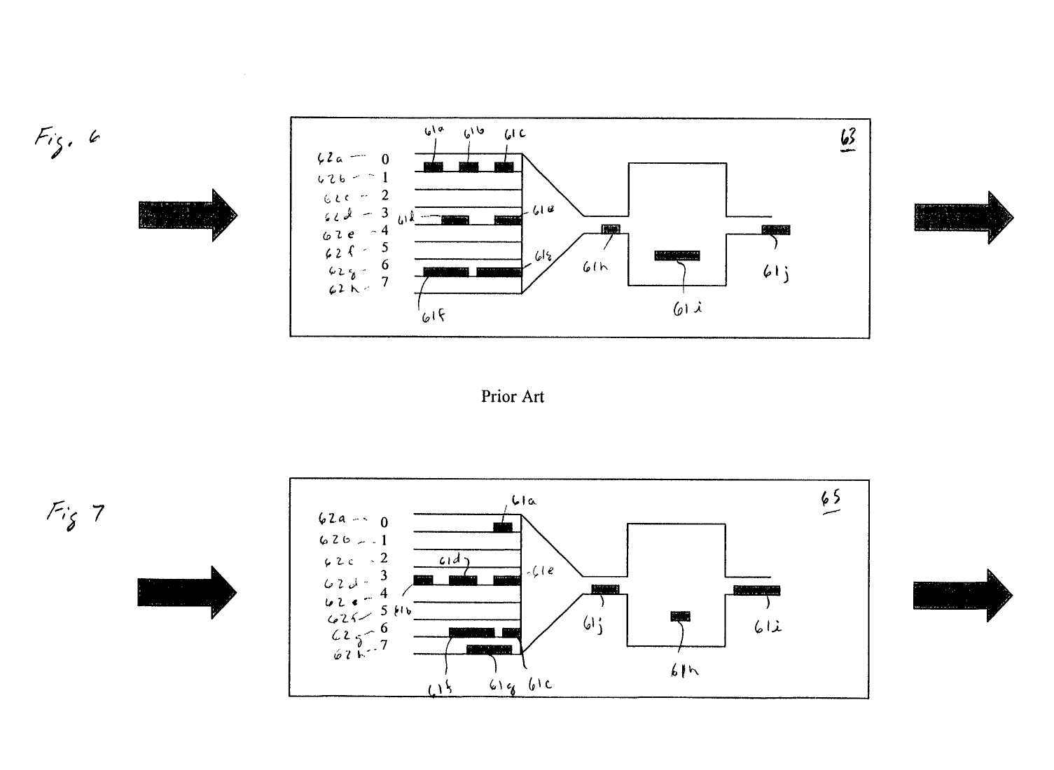

In FIG. 6, data packets 61A-61J are shown traversing a VLAN-aware device 63 having priority queues 62A-62H. A variety of different data packets are traversing this device 63. The data packets are placed into queues 62A-62H based on their priority. For example, data packets 61A-61C can be placed in priority queue 0, 62A, data packet 61D and 61E in priority queue 4, 62E, and data packets 61F and 61G in priority queue 6, 62G. Data packet 61H has just left the queue and is proceeding to be processed. Data packet 611 is currently being processed and data packet 61J has been processed and is now continuing its journey across network 4.

In FIG. 7, a VLAN-aware device in which the present invention 65 can be practiced is shown. The same data packets 61A-61J are shown crossing this device 65; however, other factors are now being accounted so that the order in which they transverse the network 4 has been changed. The fact that priorities can be modified in this way means that standard priority settings can be modified based on other factors while conforming to standard packet protocols.

Data packet 61A is in priority queue 0, 62A. Data packets 61B, 61D and 61E are all in priority queue 3, 62D. Data packets 61F and 61C are in priority queue 6, 62G and data packet 61G is in priority queue 7, 62H. It can also be seen that because of the differences in the way the data packets 61A-61J have been placed into the priority queues 62A-62H, they exit in a different order. Data packet 61J has left the queues 61A-61H and is about to be processed. Data packet 61H is currently being processed and data packet 61I has already been processed and is continuing its journey across network 4.

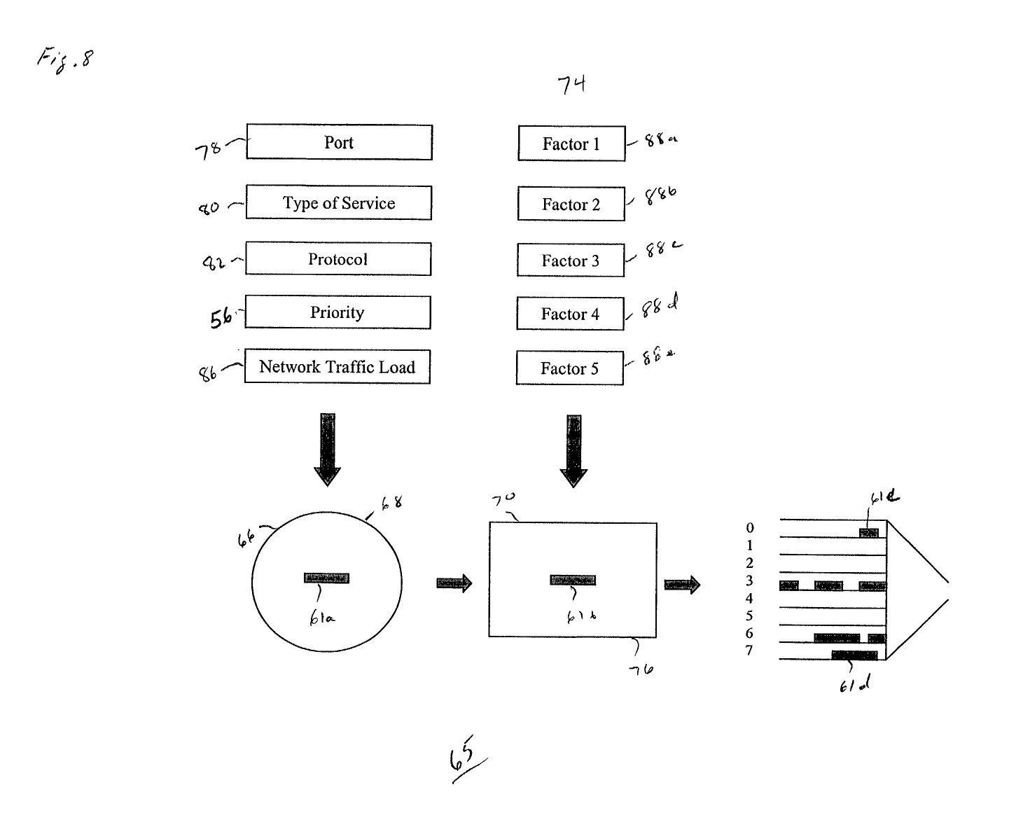

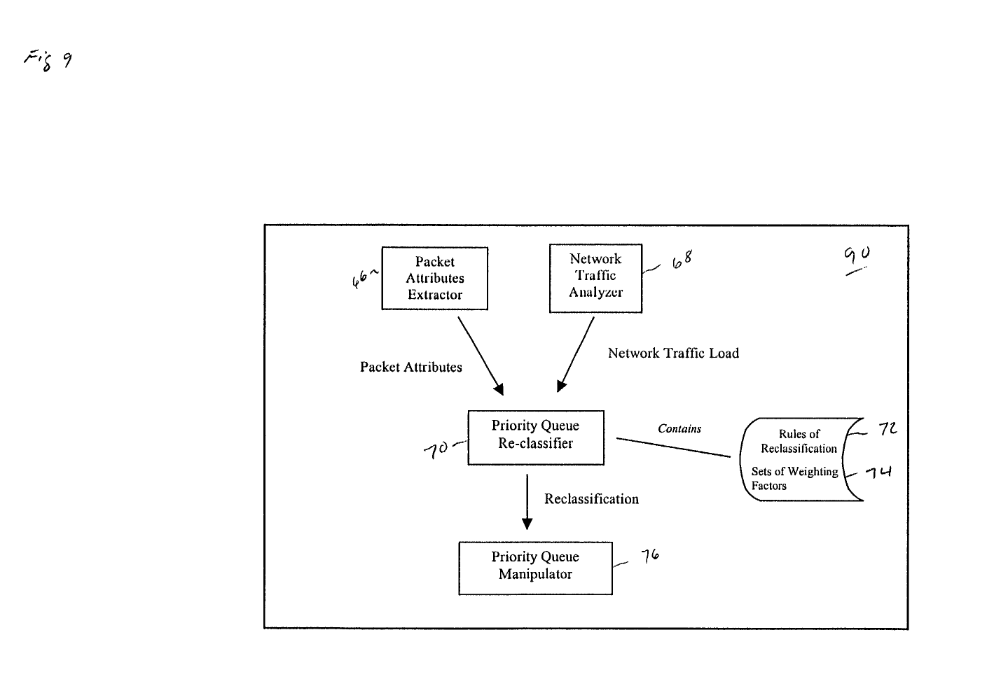

FIG. 8 illustrates the invention as it may be practiced on a data packet as it crosses through a VLAN-aware device. Data packet 61A is received into the device. Packet attribute extractor 66 extracts the following attributes: port 70A, type of service 80, protocol 82, and priority 56. Each of these pieces of information may be found in a VLAN-enabled Ethernet frame 50. Network traffic analyzer 68 will also analyze network traffic load 86 at the current time. When the information has been extracted, the information is examined and using rules of reclassification 72, standard priority settings can be modified. Data packet 61B is shown having a set of weighting factors 74 applied against the attributes and the traffic load 86. Weighting factor 1, 88A, is applied against port 78; weighting factor 2, 88B, is applied against the type of service 80; weighting factor 3, 88C, is applied against protocol 82; weighting factor 4, 88D, is applied against priority 56; and weighting factor 5, 88E is applied against the network traffic load 86.

There may be several sets of rules of reclassification 72 so that the rules may vary depending on the specific values of one or more attributes 70A, 80, 82, 56, or 86. Priority queue manipulator 76 has determined the modify queue based on applying the rules of reclassification 72. A data packet may be placed in the same queue, a higher priority queue, or a lower priority queue. For example data packet 61C has a priority field 56 value of 5, yet it has been lowered to priority queue 0 as a result of using this embodiment of the invention. Data packet 61D has a priority 56 value of 6, but has been moved up to priority queue 7 to better utilize network resources.

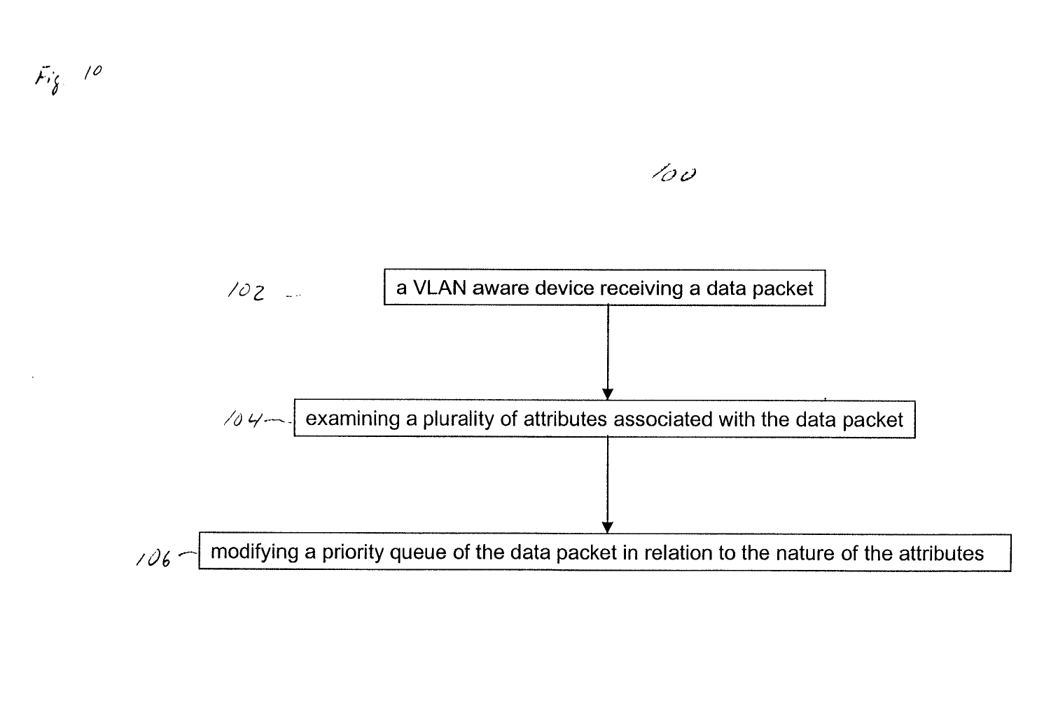

FIG. 9 is a block diagram illustrating operation of a preferred embodiment of the priority modification module 90 as disclosed. Module 90 has a means for receiving a data packet and examining attributes associated with the data packet. Network traffic analyzer 68 examines the network traffic to determine the current network traffic load. Next, module 90 modifies the priority queue of the data packet, based on packet attributes and the network traffic load, examines and compares a set of rules of reclassification 72 and sets of weighting factors 74. The results of applying the rules and weighting factors is performed in the priority queue reclassifier 70. Once the reclassification of data packet 61 has been determined, priority queue manipulator 76 will raise, lower or maintain the priority queue 62 of data packet 61 as it flows through the VLAN-aware device. Those skilled in the art will recognize that module 90 may be incorporated into any VLAN-aware device. It may be implemented in hardware, firmware or other means known to those skilled in the art. Additionally, module 90 may be placed at any position in a VLAN-aware device either prior to other processing or after other processing in the VLAN-aware device.

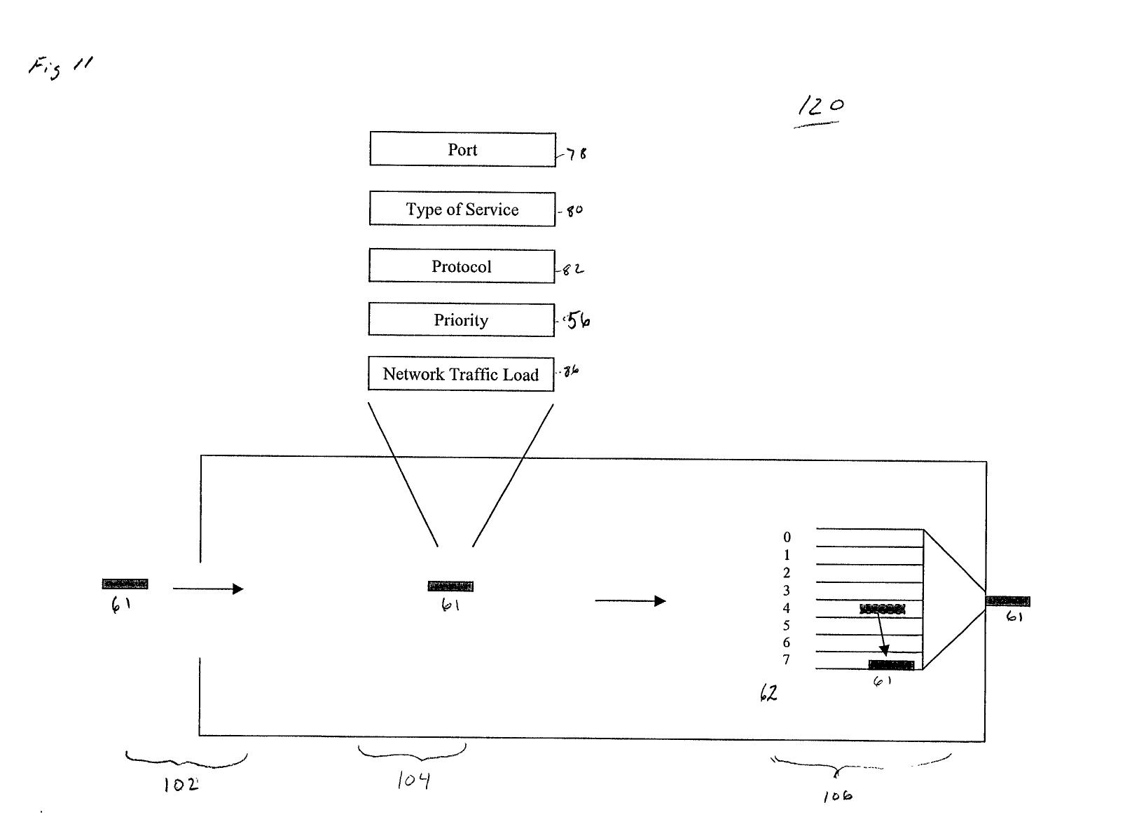

FIG. 10 is a flow chart depicting the steps of a method of modifying standard priority settings, according to the invention. Method 100 begins at step 102, wherein a VLAN-aware device receives a data packet. Next, in step 104, a plurality of the attributes associated with the data packet are examined. The priority queue of the data packet is modified in relationship to the nature of the attributes, step 106. Typically, these attributes will be a port 70A, a type of service 80, the protocol 82, the priority 56, and the current network traffic load 86. After the device has examined the attributes, a set of rules 72 is used to apply weighting factors 74 so that a result in priority may be determined. It should be noted that the resultant priority may cause the data packet 61 to be in a different queue; however, at no time is any of the data in the data packet 61 changed or modified. This allows for the data packet 61 to move through the network 4 at a different priority than it was assigned in its Ethernet priority field 56 without changing the Ethernet frame 50. Since Ethernet frame 50 is not modified in any way, the data packet 61 will continue successfully through devices that are not equipped with the ability to modify standard priority settings.

FIG. 11 is a high-level logic flow diagram 120 illustrating the method of the present invention. It can be appreciated by those skilled in the art that FIG. 11, as illustrated and described herein, presents a self-consistent sequence of steps leading to a desired result. The steps are those requiring the physical manipulation of physical quantities. Usually, although not necessarily, these quantities take the form of electrical or magnetic signals capable of being stored, transferred, combined, compared, and otherwise manipulated.

It has proven convenient at times by those skilled in the art, to refer to these signals as bits, values, elements, symbols, characters, terms, numbers, or the like. It should be borne in mind, however, that all of these and similar terms are to be associated with the appropriate physical quantities and are merely convenient labels applied to these quantities.

Further, the manipulations performed are often referred to in terms, such as “designating,” “delivering” or “conveying”, which are commonly associated with mental operations performed by a human operator. No such capability of a human operator is necessary or desirable in most cases of the operations described herein, which form part of the present invention. As indicated herein, these operations are primarily machine operations. Useful machines for performing operations of a preferred embodiment of the present invention include data-processing systems, such as a general-purpose digital computer or other similar devices. In all cases the distinction between the method of operations in operating a computer and the method of computation itself should be borne in mind.

The present invention relates to method steps for processing electrical or other (e.g. mechanical, chemical) physical signals to generate other desired physical signals, and can be implemented via a computer or microcomputer. However, it is not necessary to maintain within a computer memory of a VLAN-aware device, instructions implementing these method steps. Such instructions can be maintained within other computer memory locations. Implementation of the method described herein is left to the discretion of a particular VLAN-aware device designer.

It can be appreciated by those skilled in the art that the methods described herein can be implemented as a program product (e.g., a control program residing in a computer memory). The program product contains instructions that when executed on a CPU, carry out the operations depicted in the logic flow diagram of FIG. 11. While the present invention is described in the context of a fully functional communications network 4, those skilled in the art will further appreciate that the present invention is capable of being distributed as a program product in a variety of forms. The present invention applies equally, regardless of the particular type of signal-bearing media utilized to actually carry out the distribution. Examples of signal-bearing media include recordable-type media, such as floppy disks, hard-disk drives and CD ROM's, and transmission-type media, such as digital and analog communication links.

Preferred implementations of the invention can include implementations to execute the method of FIG. 11 described herein as a program product residing in a memory of microcomputer. Altematively, a preferred embodiment of the present invention can include a program product residing in a microcomputer memory located at an VLAN-aware device such as switch 22. The program product thus includes sets of instructions for executing the method and system described herein. Until required by a microcomputer, the set of instructions may be stored as a computer-program product in another computer memory. For example, the set of instructions may be stored as a computer-program product in a disk drive attached to a microcomputer (which may include a removable memory such as an optical disk or floppy disk for eventual use in the disk drive).

The computer-program product can also be stored at another computer and transmitted, when desired, to a VLAN-aware device by an internal or external network. Those skilled in the art will appreciate that the physical storage of the sets of instructions physically changes the medium upon which it is stored so that the medium carries computer-readable information. The change may be electrical, magnetic, chemical, or some other physical change. While it is convenient to describe the invention in terms of instructions, symbols, characters, or the like, the reader should remember that all of these and similar terms should be associated with the appropriate physical elements.

With reference to FIG. 11, at step 102, a standard data packet 61 is received and its attributes examined. These attributes include the port 78, type of service 80, protocol 82, priority 56 and network traffic load 86. Taking these attributes and applying a set of weighting factors 74, a resultant priority queue is determined. In step 106, the priority queue of the data packet 61 is modified and the data packet 61 is moved to the proper queue. In this case, for example, the priority tag in Ethernet frame 50 specified a priority queue 4; however, after applying the logic of the invention, the resultant priority queue was priority queue 7. Data packet 61 then continues from the queue throughout the network 4. It can be seen from the embodiments of the invention that the invention may be applied as a module, method or program product, depending on the embodiment.

While this invention has been described with reference to illustrative embodiments, this description is not intended to be construed in a limiting sense. Various modifications and combinations of illustrative embodiments as well other embodiments of the invention will be apparent to persons skilled in the art upon reference to the description. It is, therefore, intended that the appended claims encompass any such modifications or embodiments.

What is claimed is:

1. In a virtual local area network (VLAN) environment, a method for modifying the handling of packet data within the VLAN environment comprising the steps of:
a VLAN aware device receiving a data packet;
examining a plurality of attributes associated with the data packet; and
modifying a priority queue of the data packet in relation to the nature of said attributes.

2. The method of claim 1 wherein one of the attributes examined in the step of examining a plurality of attributes associated with the data packet is a port number in a transport layer.

3. The method of claim 1 wherein one of the attributes examined in the step of examining a plurality of attributes associated with the data packet is a type of service used in a network layer.

4. The method of claim 1 wherein one of the attributes examined in the step of examining a plurality of attributes associated with the data packet is a protocol of a network layer.

5. The method of claim 1 wherein one of the attributes examined in the step of examining a plurality of attributes associated with the data packet is a priority tag.

6. The method of claim 1 wherein one of the attributes examined in the step of examining a plurality of attributes associated with the data packet is network traffic load.

7. The method of claim 1 wherein the step of modifying the priority queue of the data packet moves the data packet to a lower priority queue.

8. The method of claim 1 wherein the step of modifying the priority queue of the data packet moves the data packet to a higher priority queue.

9. The method of claim 1 wherein the step of modifying the priority queue of the data packet keeps the data packet in the same priority queue.

10. The method of claim 1 wherein the step of modifying the priority queue of the data packet further includes the step of a pplying weighting factors to selected attributes associated with said data packets.

11. The method of claim 10 wherein said weighting factors are determined according to values of selected attributes associated with said data packets.

12. The method of claim 1 wherein said steps are preformed dynamically as data packets are received at said VLAN aware device.

13. In a virtual local area network (VLAN ) aware device, a module for modifying the handling of packet data within the VLAN environment, said module comprising:
means for receiving a data packet;
means for examining a plurality of attributes associated with the data packet; and
means for modifying the priority queue of the data packet in relation to the nature of said attributes.

14. The module of claim 13 wherein one of the attributes examined in the means for examining a plurality of attributes associated with the data packet is a port number in a transport layer.

15. The module of claim 13 wherein one of the attributes examined in the means for examining a plurality of attributes associated with the data packet is a type of service used in a network layer.

16. The module of claim 13 wherein one of the attributes examined in the means for examining a plurality of attributes associated with the data packet is a protocol of a network layer.

17. The module of claim 13 wherein one of the attributes examined in the means for examining a plurality of attributes associated with the data packet is a priority tag.

18. The module of claim 13 wherein one of the attributes examined in the means for examining a plurality of attributes associated with the data packet is network traffic load.

19. The module of claim 13 wherein the means for modifying the priority queue of the data packet moves the data packet to a lower priority queue.

20. The module of claim 13 wherein the means for modifying the priority queue of the data packet moves the data packet to a higher priority queue.

21. The module of claim 13 wherein the means for modifying the priority queue of the data packet keeps the data packet in the same priority queue.

22. The module of claim 13 wherein the means for modifying the priority queue of the data packet further includes means for applying weighting factors to selected attributes associated with said data packets.

23. The module of claim 22 wherein said weighting factors are determined according to values of selected attributes associated with said data packets.

24. In a virtual local area network (VLAN) environment, a program product for modifying the handling of packet data within the VLAN environment, said program product comprising:
logic means for receiving a data packet;
logic means for examining a plurality of attributes associated with the data packet; and
logic means for modifying the priority queue of the data packet in relation to the nature of said attributes.

25. The program product of claim 24 wherein one of the attributes examined in the logic means for examining a plurality of attributes associated with the data packet is a port number in a transport layer.

26. The program product of claim 24 wherein one of the attributes examined in the logic means for examining a plurality of attributes associated with the data packet is a type of service used in a network layer.

27. The program product of claim 24 wherein one of the attributes examined in the logic means for examining a plurality of attributes associated with the data packet is a protocol of a network layer.

28. The program product of claim 24 wherein one of the attributes examined in the logic means for examining a plurality of attributes associated with the data packet is a priority tag.

29. The program product of claim 24 wherein one of the attributes examined in the logic means for examining a plurality of attributes associated with the data packet is network traffic load.

30. The program product of claim 24 wherein the logic means for modifying the priority queue of the data packet moves the data packet to a lower priority queue.

31. The program product of claim 24 wherein the logic means for modifying the priority queue of the data packet moves the data packet to a higher priority queue.

32. The program product of claim 24 wherein the logic means for modifying the priority queue of the data packet keeps the data packet in the same priority queue.

33. The program product of claim 24 wherein the logic means for modifying the priority queue of the data packet further includes means for applying weighting factors to selected attributes associated with said data packets.

34. The program product of claim 33 wherein said weighting factors are determined according to values of selected attributes associated with said data packets.
